(19) United States
(12) Patent Application Publication
(10) Pub. No.: US 2010/0031591 A1
(43) Pub. Date: Feb. 11, 2010

(54) COMPOSITE SPACER BAR FOR REDUCING HEAT TRANSFER FROM A WARM SIDE TO A COLD SIDE ALONG AN EDGE OF AN INSULATED GLAZING UNIT

(76) Inventor: Raymond G. GALLAGHER, Pittsburgh, PA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/549,773

(22) Filed: Aug. 28, 2009

Related U.S. Application Data
(63) Continuation-in-part of application No. 11/686,714, filed on Mar. 15, 2007.

(51) Int. Cl. E06B 3/667

(52) U.S. Cl. 52/204.591; 52/786.13

(57) ABSTRACT

The subject application is directed to a composite spacer bar for use in glazing units. The spacer bar includes a low-thermally conductive inner component and a low-thermally conductive outer component that partially encases the inner component. The inner component has four walls of a predetermined thickness that define a chamber containing a low-thermally conductive material. The thickness of the outer component is substantially less than the thickness of the inner component. The outer component also includes a rear wall having an irregular profile and associated longitudinal edges, with the inner component configured to engage the longitudinal edges of the outer component. The longitudinal edges also include a portion that extends a predetermined distance into the top wall of the inner component. The composite spacer bar is also configured to receive a linear key member that is configured for insertion into the chamber so as to join ends of the spacer bar.

### CROSS-REFERENCE TO RELATED APPLICATION

This application is a continuation in part of U.S. application Ser. No. 11/686,714 filed on Mar. 15, 2007.

### BACKGROUND

The subject application is directed to a system, method and spacer bar for reducing heat transfer between glazings in an insulated glazing unit. In particular, the subject application is directed to a spacer bar for reducing the amount of heat transferred from the warm side to the cold side along an edge of an insulated glazing unit.

In the field of insulating glazing units, the use of a tubular spacer bar to separate panes of glazing forming an insulated glazing unit are typically used. Common practice dictates, when forming a rectangular glazing unit, to cut a spacer bar into specific lengths and connect the four pieces using some sort of connector device or corner key to form the corners of the spacer arrangement, or frame, of the glazing unit. The device used to connect the spacer pieces to form the corners of the frame is referred to as a corner key. Alternatively, a corner of a frame is suitably bent, in which case a linear key is implemented. In addition, miscellaneous pieces of spacer bar are generally used to form a length of the frame, so as to conserve spacer material, connected via some linear connecting device. The design of the corner key and its material varies, including stamped metal, cast alloy piece, injected molded plastic, and the like. This leads to at least four points at which leaks are capable of developing, as well as gaps in the spacer component such that continuous insulation is impossible, irrespective of the type of connector device used. Bending of a single piece of spacer material so as to minimize connector device usage has been implemented via a linear key arrangement. However, even limiting the connection to a single joint does not entirely minimize heat transfer.

Thus, there exists a need for a system, method, and apparatus to minimize the heat transfer from a warm side of the insulated glazing unit to the cold side of the insulated glazing unit.

### SUMMARY OF INVENTION

In accordance with one embodiment of the subject application, there is provided an energy conservation device for implementation in an insulated glazing unit.

Further, in accordance with one embodiment of the subject application, there is provided a spacer bar for reducing the amount of heat transferred from the warm side to the cold side along an edge of an insulated glazing unit having an increased path length and minimal secondary sealant.

Still further, in accordance with one embodiment of the subject application, there is provided a system, method and device for reducing heat transfer between components of an insulated glazing unit.

In accordance with one embodiment of the subject application, there is provided a spacer bar for heat transfer reduction in an insulated glazing unit. The spacer bar includes a spacer back, comprised of plastic-lined, low conductivity metal of extended length, and an airspace bridge comprised of a low conductivity plastic.

In one embodiment of the subject application, there is provided a composite spacer bar. The spacer bar includes a low-thermally conductive inner component having four walls of a predetermined thickness, that define a chamber disposed therein containing a low-thermally conductive material. The spacer also includes a low-thermally conductive outer component that partially encases the inner component. The thickness of the outer component is substantially less than the thickness of the inner component. The outer component further includes a rear wall and a plurality of associated longitudinal edges. Additionally, the longitudinal edges include a portion that extends a predetermined distance into the top wall of the inner component. The inner component is also configured to fit within the outer component and engage the plurality of longitudinal edges associated with the outer component. The composite spacer bar is also configured to receive a linear key member, that is configured for insertion into the chamber so as to join ends of the spacer bar.

In accordance with one embodiment of the subject application, heat transfer along the rear wall of the outer component is minimized by extending the length of the rear wall, the latter being achieved by constructing the rear wall with an irregular profile. The profile can be deformed in any suitable way, for example, and without limitation, it can be bent, oblique, or corrugated. In the latter case it can be wavy, or include, for example, an without limitation, at least one rib, groove, or ridge. The dimensions of the irregularities of the rear wall profile are determined by desired thermal performance of the insulated glazing unit, and specifically of the spacer bar.

In another embodiment of the subject application, the inner component is constructed of a low-thermally conductive plastic material. Furthermore, the low-conductivity material within the chamber comprises a thermally-insulative gas, a thermally-insulative material, and/or a desiccant material.

In yet another embodiment of the subject application, the outer component of the spacer bar is constructed of a butyl-wrapped, low-thermally conductive metal and/or a multilayered tape.

In one embodiment the subject application, the ends of the composite spacer bar joined by the linear key square cut and de-burred. In addition, the linear key is comprised of a non-porous material. Furthermore, the spacer bar in such an embodiment includes a sealant overlay emplaced on the ends of the composite space bar joined by the linear key.

In accordance with one embodiment of the subject application, there is provided an insulated-glazing unit, comprising at least two glazing panes arranged to oppose each other, and a composite spacer bar frame formed from a composite spacer bar separating the at least two glazing panes and defining a space therebetween. The spacer bar includes a low thermal conductivity inner component having four walls of a predetermined thickness, defining a chamber disposed therein containing a low thermal conductivity material. The spacer bar also includes a low thermal conductivity outer component partially encasing the inner component having a thickness substantially less than the thickness of the inner component, the outer component including a rear wall and a plurality of longitudinal edges associated therewith. The longitudinal edges of the outer component include a portion extending a predetermined distance into a top wall of the inner component. The inner component of the spacer bar is configured to fit within the outer component and engage the longitudinal edges associated with the outer component. Additionally, the composite spacer bar is configured to receive a linear key member, the linear key member configured for insertion into the chamber so as to join ends of the spacer bar.

In one embodiment of the subject application, the space defined between the spacer bar frame and the glazing panes contains air and/or an inert gas.

In another embodiment of the subject application, the inner component is comprised of a low thermally conductive plastic material.

In yet another embodiment of the subject application, the low-conductivity material contained within the chamber comprises at least one of the group consisting of a thermally-insulative gas, a thermally-insulative material and a desiccant material.

In a further embodiment of the subject application, the outer component of the composite spacer bar is comprised of at least one of the group consisting of a butyl-wrapped, low thermally conductive metal and a multilayered tape.

Still other objects, advantages and aspects of the subject application will become readily apparent to those skilled in this art from the following description wherein there is shown and described preferred embodiments of this application, simply by way of illustration of the best modes suited to carry out the subject application. As it will be realized by those skilled in the art, the subject application is capable of other different embodiments and its several details are capable of modifications in various obvious aspects all without departing from the subject application. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the subject application, and together with the description serve to explain the principles of the subject application. In the drawings:

FIG. 1 illustrates a cross-sectional view of one embodiment of a spacer bar in accordance with one embodiment of the subject application;

FIG. 2 illustrates a cross-sectional view of one embodiment of a spacer bar in accordance with one embodiment of the subject application;

FIG. 3A illustrates a cross-sectional view of one embodiment of a spacer bar in accordance with one embodiment of the subject application;

FIG. 3B illustrates a top view of a spacer in accordance with one embodiment of the subject application;

FIG. 3C illustrates a cross-sectional view of an outer component of a spacer in accordance with one embodiment of the subject application;

FIG. 3D illustrates the intersection of an outer component and an inner component of a spacer in accordance with one embodiment of the subject application;

FIG. 3E illustrates a side view a spacer in accordance with one embodiment of the subject application;

FIG. 3F illustrates a spacer in accordance with one embodiment of the subject application;

FIG. 4 illustrates a cross-sectional view of one embodiment of an insulated glazing unit with a spacer bar in accordance with one embodiment of the subject application; and

FIG. 5 illustrates a cross-sectional view of one embodiment of an insulated glazing unit with a spacer bar in accordance with one embodiment of the subject application.

### DETAILED DESCRIPTION OF THE PREFERRED AND ALTERNATE EMBODIMENTS

The subject application is directed to an energy conservation device for implementation in an insulated glazing unit. In particular, the subject application is directed to a spacer bar for reducing the amount of heat transferred from the warm side to the cold side along an edge of an insulated glazing unit. More particularly, there is provided a system, method, and device for reducing heat transfer between components of an insulated glazing unit.

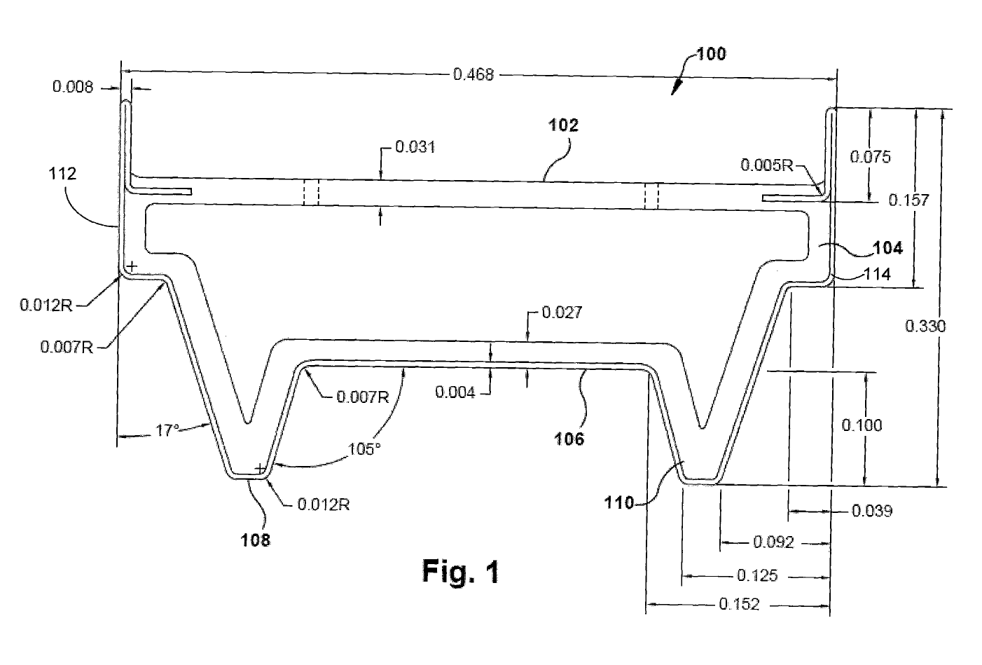

Turning now to FIG. 1, there is shown a cross-sectional view of a spacer bar 100 in accordance with the subject application. As shown in FIG. 1, the spacer bar is comprised of an inner component 102 and an outer component 104. Preferably, the inner component 102 is composed of a suitable plastic material as is known in the art. The inner component 102, or liner is advantageously affixed, via any suitable means, to the outer component 104. The outer component includes a rear wall 106 and a plurality of lengthwise edges 112 and 114. In one embodiment, the outer component 104 is stainless steel, other suitable metal, or multilayer tape, wherein the butyl coating is suitably applied during manufacturing of the insulated glazing unit. As shown in FIG. 1, the outer component 104 is of a substantially smaller thickness than that of the inner liner 102. The skilled artisan will appreciate that the measurements illustrated in FIG. 1 are for illustration purposes only and the subject application is not limited to the angular, thickness, width, lengths, and materials shown in FIG. 1. The inner component 102 is formed to receive an extended portion of the outer component 104 such that the lengthwise edges 112 and 114 of the outer component 104 extend into the sides of the outward face portion of the inner component 102.

As depicted in FIG. 1, the rear wall 106 of the outer component 104 has an extended length, the latter being achieved by constructing the rear wall 106 with an irregular profile. In the embodiment of FIG. 1 the rear wall 106 includes two ridges 108 and 110. Those skilled in the art will appreciate that the profile of the rear wall 106 including two ridges 108 and 110 is presented for illustration purposes only. For example, the profile of the rear wall 106 may include three ridges or any number of suitable ridges. Those skilled in the art will appreciate that the profile of the rear wall 106 can be deformed in any suitable way, for example, and without limitation, it can be bent, oblique, or corrugated. In the latter case it can be wavy, or include, for example, and without limitation, at least one rib, groove, or ridge. The dimensions of the irregularities of the profile of the rear wall 106 are determined by necessary thermal performance of the insulated glazing unit, and specifically of the spacer. The skilled artisan will appreciate that the dimensions of the irregularities in FIG. 1 are for illustration purposes only and the subject application is not limited to the angular, thickness, width, lengths, and materials shown in FIG. 1.

As illustrated in FIG. 1, the cross-sectional view of the spacer 100 indicates a hollow opening, running lengthwise of the spacer. The contents of the hollow opening include any suitable material known in the art of glazing unit manufacturing. In one embodiment, a linear-key member (not shown) is advantageously used so as to connect two ends of the spacer 100 to form a frame of one continuous piece of spacer material. Those skilled in the art will appreciate that the subject application is not limited to a single continuous piece and that a number greater than one of spacer pieces are equally capable of being used in accordance with the subject application. The overall height of the spacer, illustrated in FIG. 1, is 0.330″, which provides increased spacer stiffness to the spacer 100 over more commonly used spacers, as will be appreciated by those skilled in the art. In an alternate embodiment, the height of the spacer is 0.267″.

It will further be understood by those skilled in the art that the shape and construction of the spacer 100, as illustrated by the cross-sectional view of FIG. 1, enables vast cost-savings in the reduced amount of secondary sealant required by the subject application. The secondary sealant volume per foot of common spacers is typically 0.891 cubic inches per foot that results in 25.9 units per gallon of sealant for 2′×3′ units. With a sealant price of $19.20 per gallon, each 2′×3′ unit with a full secondary sealant includes $0.74 per unit for the secondary sealant. As the skilled artisan will appreciate with respect to the spacer illustrated in FIGS. 1-5, the estimated secondary sealant volume per unit is only 0.220 cubic inches per foot or only about ¼ the full coverage and a $0.19 per unit sealant cost. Thus, there is a savings of $0.55 per unit. Therefore, a high volume insulated glazing manufacturer will realize “substantial” annual savings.

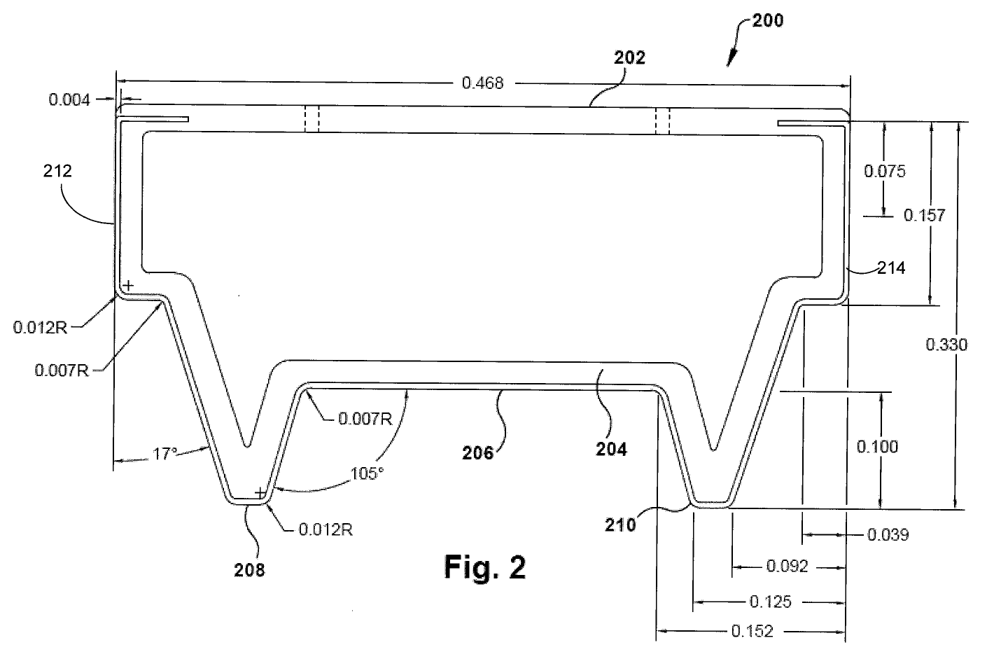

Referring now to FIG. 2, there is shown a cross-sectional view of a spacer 200 in accordance with one embodiment of the subject application. The spacer 200 illustrated in FIG. 2 also includes an inner component 202 and an outer component 204. Accordingly, the inner component 202 is preferably constructed of a suitable low-conductivity plastic material, as is known in the art. The outer component 204 comprises a rear wall 206 and a plurality of longitudinal edges 212 and 214. The inner component 202 is suitably formed such that the longitudinal edges of the outer component 204 are bent at an angle and inserted into slots along the sides of the inner component 202, as demonstrated in FIG. 2. Preferably, the outer component 204 is constructed of a suitable metal material having low-conductivity with respect to heat transfer. More preferably, the outer component 204 comprises butyl coated stainless steel, other suitable metal, or multilayer tape. As previously iterated, the thickness of the inner component 202 is substantially larger than the thickness of the outer component 204.

As illustrated in FIG. 2, the rear wall 206 of the outer component 204 has an extended length, the latter being achieved by constructing the rear wall 206 with an irregular profile. In the embodiment of FIG. 2 the rear wall 206 includes two ridges 208 and 210. Those skilled in the art will appreciate that the profile of the rear wall 206 including two ridges 208 and 210 is presented for illustration purposes only. For example, the profile of the rear wall 206 may include three ridges or any number of suitable ridges. Those skilled in the art will appreciate that the profile of the rear wall 206 can be deformed in any suitable way, for example, and without limitation, it can be bent, oblique, or corrugated. In the latter case it can be wavy, or include, for example, and without limitation, at least one rib, groove, or ridge. The dimensions of the irregularities of the profile of the rear wall 206 are determined by necessary thermal performance of the insulated glazing unit, and specifically of the spacer. The skilled artisan will appreciate that the dimensions of the irregularities in FIG. 2 are for illustration purposes only and the subject application is not limited to the angular, thickness, width, lengths, and materials shown in FIG. 2.

As illustrated in FIG. 2, the cross-sectional view of the spacer 200 indicates a hollow opening, running lengthwise of the spacer. The contents of the hollow opening include any suitable material known in the art of glazing unit manufacturing. In one embodiment, a linear-key member (not shown) is advantageously used so as to connect two ends of the spacer 200 to form a frame of one continuous piece of spacer material. Those skilled in the art will appreciate that the subject application is not limited to a single continuous piece and that a number greater than one of spacer pieces are equally capable of being used in accordance with the subject application. The overall height of the spacer, illustrated in FIG. 2, is 0.330″, which provides increased spacer stiffness to the spacer 200 over more commonly used spacers, as will be appreciated by those skilled in the art. In an alternate embodiment, the height of the spacer is 0.267″. The skilled artisan will further appreciate that the spacer 200 illustrated in FIG. 2 does not include the folded over portion of the outer component 104, as shown in FIG. 1. In place of the folded over portion of FIG. 1, the spacer 200 incorporates an additional amount of inner material such that no folded portion is needed to extend the height of the spacer 200 to 0.330″, as set forth in FIG. 1.

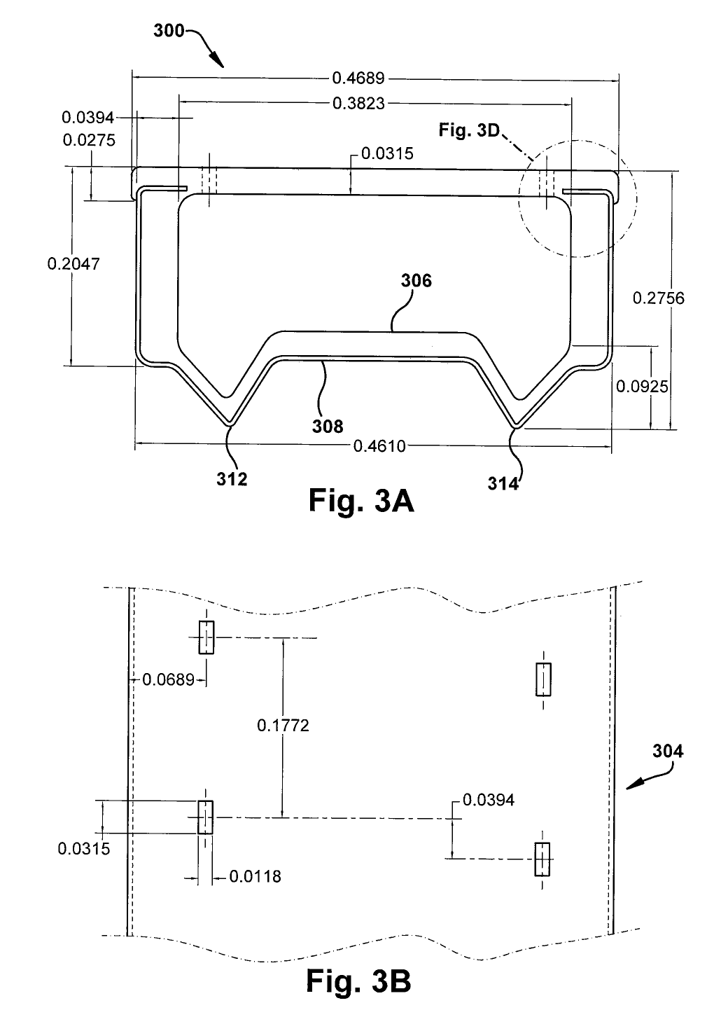

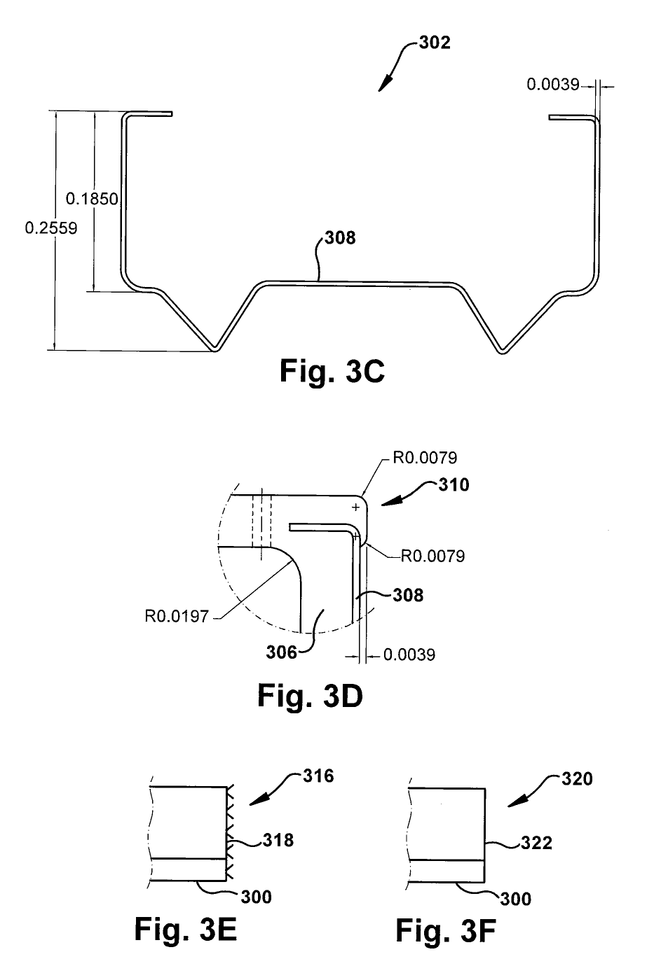

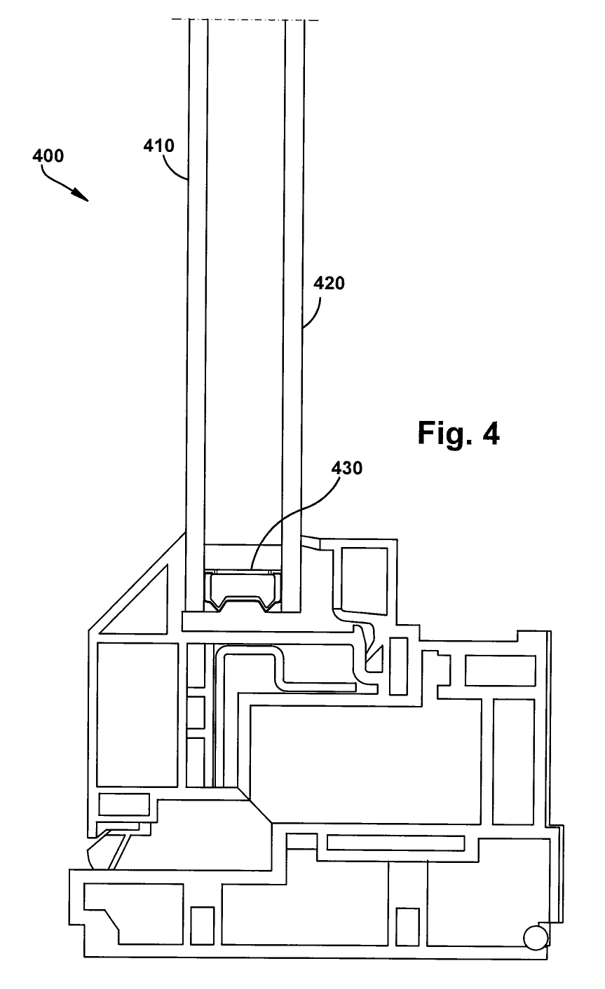

Turning now to FIG. 3A, there is shown a cross-sectional view of a spacer 300 in accordance with one embodiment of the subject application. FIG. 3C further illustrates a cross-sectional view 302 of an outer component 308. FIG. 3B further illustrates a top view 304 of the spacer 300 of FIG. 3A. FIG. 3D further illustrates a cut-out view 310 illustrating the intersection of the outer component 308 and an inner component 306 according to the subject application. FIG. 3E further illustrates a side view 316 of spacer 300 of FIG. 3A. FIG. 3F further illustrates a side view 320 of spacer 300 of FIG. 3A. The spacer 300 illustrated in FIG. 3A also includes an inner component 306 and an outer component 308. Accordingly, the inner component 306 is preferably constructed of a suitable low-conductivity plastic material, and formed such that the longitudinal edges of the outer component 308 are bent at an angle and engage slots along the sides of the inner component 306, as demonstrated in FIG. 3A. Preferably, the outer component 308 is constructed of a suitable low-conductivity metal material, including, for example and without limitation, butyl coated stainless steel, other suitable metal or multilayer tape. As previously iterated, the thickness of the inner component 306 is substantially larger than the thickness of the outer component 308. As shown in the cross-sectional view 302 of FIG. 3C and the cut-out view 310 of FIG. 3D, the outer component is of approximately 0.0039906″ thick, whereas the thickness of the inner component 306 is of varying thicknesses. According to one example embodiment, as shown in side view 316 of spacer 300 in FIG. 3E, end 318 is square cut. According to one example embodiment, as shown in side view 320 of spacer 300 in FIG. 3F, end 322 is de-burred.

As illustrated in FIG. 3A, a rear wall of the outer component 308 has an extended length, the latter being achieved by constructing the rear wall with an irregular profile. In the embodiment of FIG. 3 the rear wall includes two ridges 312 and 314. Those skilled in the art will appreciate that the profile of the rear wall including two ridges 312 and 314 is presented for illustration purposes only. For example, the profile of the rear wall may include three ridges or any number of suitable ridges. Those skilled in the art will appreciate that the profile of the rear wall can be deformed in any suitable way, for example, and without limitation, it can be bent, oblique, or corrugated. In the latter case it can be wavy, or include, for example, and without limitation, at least one rib, groove, or ridge. The dimensions of the irregularities of the profile of the rear wall are determined by necessary thermal performance of the insulated glazing unit, and specifically of the spacer. The skilled artisan will appreciate that the dimensions of the irregularities in FIG. 3A are for illustration purposes only and the subject application is not limited to the angular, thickness, width, lengths, and materials shown in FIG. 3A.

As illustrated by the cross-sectional view 302 of the subject application, the outer component 304 is pre-bent into an acceptable shape for coupling the inner component 306 to the outer component 308. The inner component 306 is formed to create a tubular hollow opening, running lengthwise of the spacer 300. The contents of the tubular opening include any suitable material known in the art of glazing unit manufacturing. Preferably, the hollow is partially filled with a desiccant material. In other embodiments of the subject application, the hollow contains a low-heat transfer material, such as a gas, foam, or the like, advantageously having low-conductivity with respect to heat transfer. In one embodiment, a linear-key member (not shown) is used to connect two ends of the spacer 300 to form a frame of one continuous piece. Those skilled in the art will appreciate that the subject application is not limited to a single continuous piece and that a number greater than one of spacer pieces are equally capable of being used in accordance with the subject application. The skilled artisan will further appreciate that similar to the spacer 200 of FIG. 2, the spacer 300 illustrated in FIG. 3 does not include the folded over portion of the outer component 104, as shown in FIG. 1. In place of the folded over portion of FIG. 1, the spacer 300 incorporates an additional amount of inner material such that no folded portion is needed to extend the height of the spacer 300 to 0.330″, as set forth in FIG. 1.

The forgoing description allows for appreciation of significant advantages associated with disclosed structure. The disclosed spacer technology results in a higher stiffness. This advantage is attributable to the shape and dimensions chosen for the spacer design. A height of a space is suitably 0.33 inches, which is more than the 0.276 inches to which earlier bending machines have been adjusted. Significant adjustment of fabrication machinery is costly and time consuming.

The disclosed spacer also allows for improved, lowered thermal conductivity. This is resultant from a longer metal path and missed sealing at a lower portion that forms a secondary seal. The improved design counteracts thermal loss that would otherwise be expected given an absence of such a secondary seal. The absence of this seal also results in a substantial cost savings during fabrication.

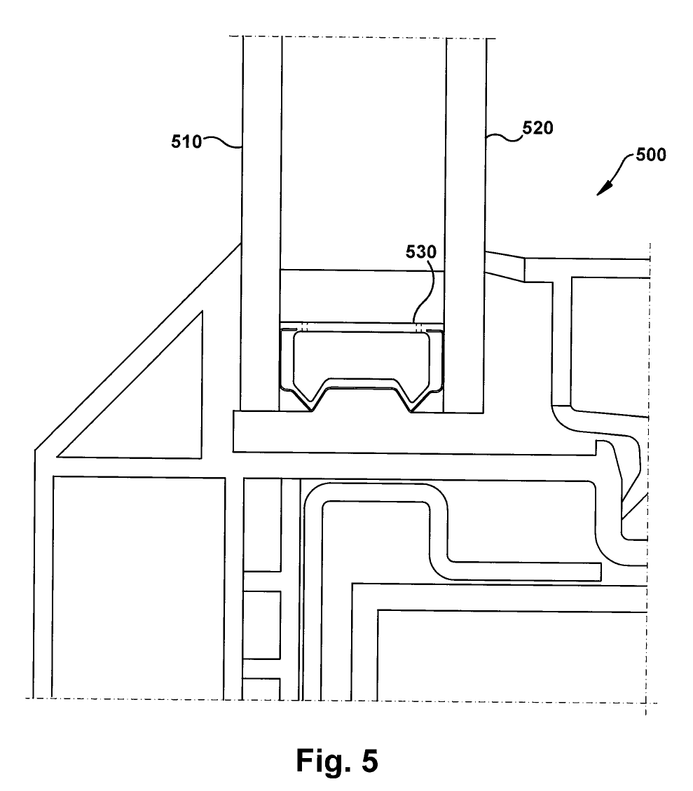

Turning now to FIG. 4, there is shown a cross-sectional view of one embodiment of an insulated glazing unit 400 with a spacer bar 430 in accordance with one embodiment of the subject application. Insulated glazing unit 400 comprises a first glazing pane 410 and a second glazing pane 420 arranged to appose each other. Spacer bar 430 separates first glazing pane 410 and second glazing pane 420 and defines a space therebetween. The spacer bar 430 includes a low thermal conductivity inner component having four walls of a predetermined thickness, defining a chamber disposed therein containing a low thermal conductivity material. The spacer bar 430 also includes a low thermal conductivity outer component partially encasing the inner component having a thickness substantially less than the thickness of the inner component, the outer component including a rear wall and a plurality of longitudinal edges associated therewith. The outer component includes a folded over portion that extends the height of the longitudinal edges. The rear wall has an extended length achieved by constructing the rear wall with an irregular profile. The longitudinal edges of the outer component include a portion extending a predetermined distance into a top wall of the inner component. The inner component of the spacer bar is configured to fit within the outer component and engage the longitudinal edges associated with the outer component. Additionally, the spacer bar 430 is configured to receive a linear key member, the linear key member configured for insertion into the chamber so as to join ends of the spacer bar. In one embodiment of the subject application, the space defined by the spacer bar 430 between the first and second glazing panes 410 and 420 contains air and/or an inert gas. It will be appreciated by those skilled in the art that the irregular profile of the rear wall of the spacer bar 430 provides for reducing the amount of heat transferred between first and second glazing panes 410 and 420. Those skilled in the art will appreciate that the profile of the rear wall of spacer bar 430 including two ridges is presented for illustration purposes only. For example, the profile of the rear wall may include three ridges or any number of suitable ridges.

Referring now to FIG. 5, there is shown a cross-sectional view of one embodiment of an insulated glazing unit 500 with a spacer bar 530 in accordance with one embodiment of the subject application. Insulated glazing unit 500 comprises a first glazing pane 510 and a second glazing pane 520 arranged to appose each other. Spacer bar 530 separates first glazing pane 510 and second glazing pane 520 and defines a space therebetween. The spacer bar 530 includes a low thermal conductivity inner component having four walls of a predetermined thickness, defining a chamber disposed therein containing a low thermal conductivity material. The spacer bar 530 also includes a low thermal conductivity outer component partially encasing the inner component having a thickness substantially less than the thickness of the inner component, the outer component including a rear wall and a plurality of longitudinal edges associated therewith. The rear wall has an extended length achieved by constructing the rear wall with an irregular profile. The longitudinal edges of the outer component include a portion extending a predetermined distance into a top wall of the inner component. The inner component of the spacer bar is configured to fit within the outer component and engage the longitudinal edges associated with the outer component. Additionally, the spacer bar 530 is configured to receive a linear key member, the linear key member configured for insertion into the chamber so as to join ends of the spacer bar. In one embodiment of the subject application, the space defined by the spacer bar 530 between the first and second glazing panes 510 and 520 contains air and/or an inert gas. The skilled artisan will appreciate that the irregular profile of the rear wall of the spacer bar 530 provides for reducing the amount of heat transferred between first and second glazing panes 510 and 520. Those skilled in the art will appreciate that the profile of the rear wall of spacer bar 530 including two ridges is presented for illustration purposes only. For example, the profile of the rear wall may include three ridges or any number of suitable ridges. The skilled artisan will further appreciate that the spacer bar 530 does not include a folded over portion, as shown in FIG. 4.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A composite spacer bar, comprising:
a low thermal conductivity inner component having four walls of a predetermined thickness, defining a chamber disposed therein containing a low thermal conductivity material; and
a low thermal conductivity outer component partially encasing the inner component having a thickness substantially less than the thickness of the inner component, the outer component including a rear wall having an irregular profile and a plurality of longitudinal edges associated therewith,
wherein the longitudinal edges include a portion thereof extending a predetermined distance into a top wall of the inner component,
wherein the inner component is configured to fit within the outer component and engage the plurality of longitudinal edges associated with the outer component, and
wherein the composite spacer bar is configured to receive a linear key member, the linear key member configured for insertion into the chamber so as to join ends of the spacer bar.

2. The composite spacer bar of claim 1, wherein the inner component is comprised of a low thermally conductive plastic material.

3. The composite spacer bar of claim 2, wherein the low-conductivity material contained within the chamber comprises at least one of the group consisting of a thermally-insulative gas, a thermally-insulative material, and a desiccant material.

4. The composite spacer bar of claim 1, wherein the outer component is comprised of at least one of the group consisting of a butyl-wrapped, low thermally conductive metal and a multilayered tape.

5. The composite spacer bar of claim 1, wherein the ends of the composite spacer bar joined by the linear key are square cut.

6. The composite spacer bar of claim 5, wherein the ends of the composite space bar joined by the linear key are de-burred.

7. The composite spacer bar of claim 6, wherein the linear key is comprised of a non-porous material.

8. The composite spacer bar of claim 7, further comprising a sealant overlay emplaced on the ends of the composite space bar joined by the linear key.

9. The composite spacer bar of claim 1, wherein the rear wall is deformed, the rear wall is at least one of the group consisting of bent, oblique, and corrugated.

10. The composite space bar of claim 9, wherein the rear wall comprises at least one of the group consisting of a ridge, a rib, and a groove.

11. An insulated-glazing unit, comprising:
at least two glazing panes arranged to oppose each other; and
a composite spacer bar frame formed from a composite spacer bar separating the at least two glazing panes and defining a space therebetween, the spacer bar including:
a low thermal conductivity inner component having four walls of a predetermined thickness, defining a chamber disposed therein containing a low thermal conductivity material, and
a low thermal conductivity outer component partially encasing the inner component having a thickness substantially less than the thickness of the inner component, the outer component including a rear wall having an irregular profile and a plurality of longitudinal edges associated therewith,
wherein the longitudinal edges include a portion thereof extending a predetermined distance into a top wall of the inner component,
wherein the inner component is configured to fit within the outer component and engage the plurality of longitudinal edges associated with the outer component, and
wherein the composite spacer bar is configured to receive a linear key member, the linear key member configured for insertion into the chamber so as to join ends of the spacer bar.

12. The insulated-glazing unit of claim 11, wherein the space defined between the spacer bar frame and the glazing panes contains at least one of the group consisting of air and an inert gas.

13. The insulated-glazing unit of claim 12, wherein the inner component is comprised of a low thermally conductive plastic material.

14. The insulated-glazing unit of claim 13, wherein the low-conductivity material contained within the chamber comprises at least one of the group consisting of a thermally-insulative gas, a thermally-insulative material, and a desiccant material.

15. The insulated-glazing unit of claim 12, wherein the outer component is comprised of at least one of the group consisting of a butyl-wrapped, low thermally conductive metal and a multilayered tape.

16. The insulated-glazing unit of claim 11, wherein the rear wall is deformed, the rear wall is at least one of the group consisting of bent, oblique, and corrugated.

17. The insulated-glazing unit of claim 16, wherein the rear wall comprises at least one of the group consisting of a ridge, a rib, and a groove.
